(19) United States
(12) Patent Application Publication
(10) Pub. No.: US 2026/0052088 A1
(43) Pub. Date: Feb. 19, 2026

(54) BI-DIRECTIONAL TRACEROUTE FOR LINK AND NODE LATENCY ESTIMATIONS

(71) Applicant: Cisco Technology, Inc., San Jose, CA (US)

(72) Inventors: Federico Lovison, Fontanelle (IT); Andrea Di Pietro, Parasols (FR); Rinaldo Buratti, San Francisco, CA (US)

(73) Assignee: Cisco Technology, Inc., San Jose, CA (US)

(21) Appl. No.: 18/807,208

(22) Filed: Aug. 16, 2024

(51) Int. Cl. H04L 43/10; H04L 43/045; H04L 43/0864

(52) U.S. Cl. CPC H04L 43/10; H04L 43/045; H04L 43/0864

(57) ABSTRACT

In one implementation, a device obtains traceroute results for a forward path from a first endpoint in a network to a second endpoint in the network that indicates a plurality of intermediate nodes along the forward path. The device causes the second endpoint to perform traceroute testing with respect to the plurality of intermediate nodes, to obtain traceroute results for a reverse path between the second endpoint and the first endpoint that includes the plurality of intermediate nodes. The device computes a delay metric associated with a particular intermediate node among the plurality of intermediate nodes, based on the traceroute results for the forward path and the traceroute results for the reverse path. The device provides the delay metric for presentation via a user interface.

### TECHNICAL FIELD

The present disclosure relates generally to computer systems, and, more particularly, to bi-directional traceroute for link and node latency estimations.

### BACKGROUND

As computer networks continue to grow in size and complexity, so too have the challenges in monitoring their performance. Indeed, traffic in a network may span any number of devices (e.g., access points, routers, etc.), paths, points of presence (PoPs) autonomous systems, and the like. Thus, identifying when performance is degraded in the network, as well as the root cause of that degradation, requires a high degree of visibility into the network.

Throughout the years, various traceroute mechanisms have evolved, to identify the intermediate nodes in a network between two points and capture performance metrics along that path. While traceroute testing from one endpoint to another is able to capture metrics such as packet loss and latency, doing so does not provide any information regarding the processing latencies introduced by each intermediate node, nor to the delay over each of the links between the intermediate nodes. Simply performing traceroute testing in both directions is also not a guaranteed way to capture information to estimate these metrics, either, because there is no guarantee that the path taken from the second endpoint back to the first endpoint will be the same as the path from the first endpoint to the second endpoint.

### BRIEF DESCRIPTION OF THE DRA WINGS

The implementations herein may be better understood by referring to the following description in conjunction with the accompanying drawings in which like reference numerals indicate identically or functionally similar elements, of which:

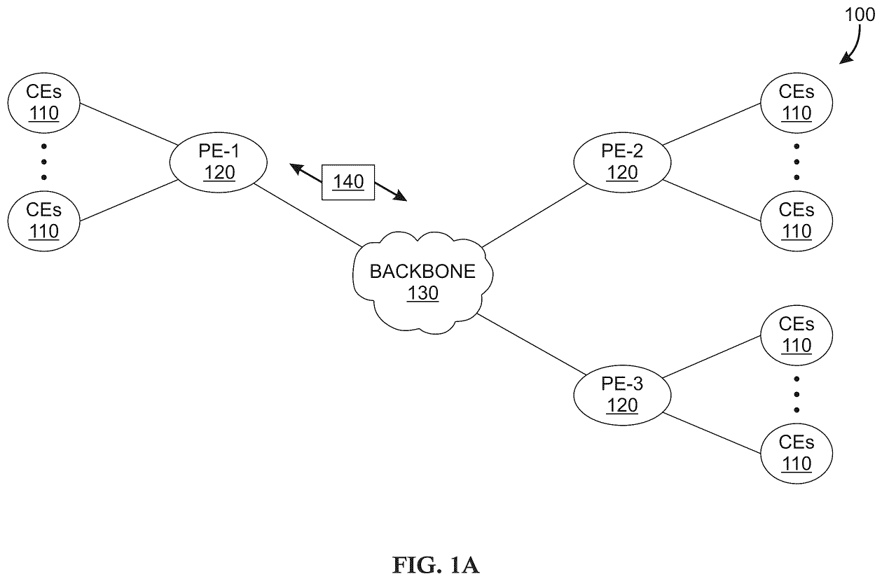

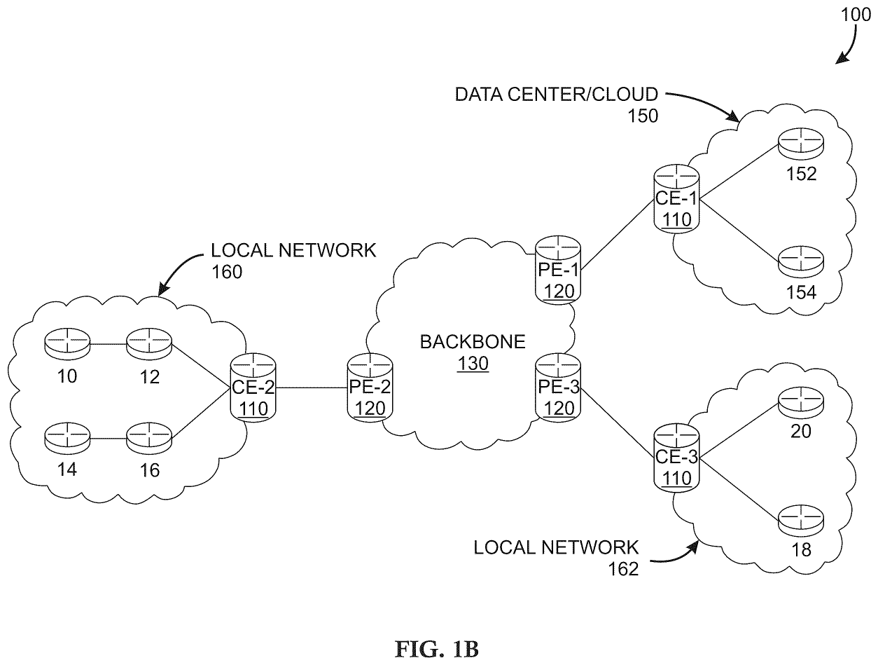

FIGS. 1A-1B illustrate an example communication network;

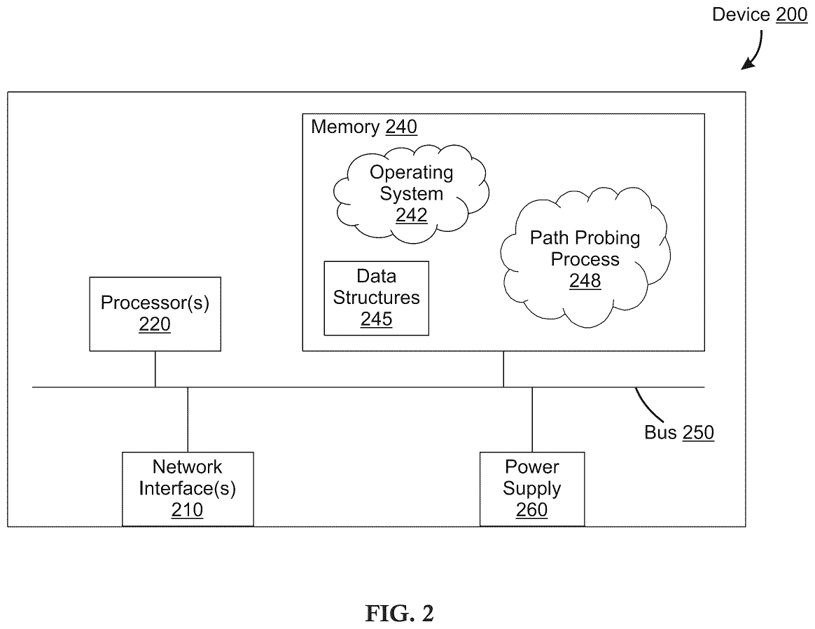

FIG. 2 illustrates an example network device/node;

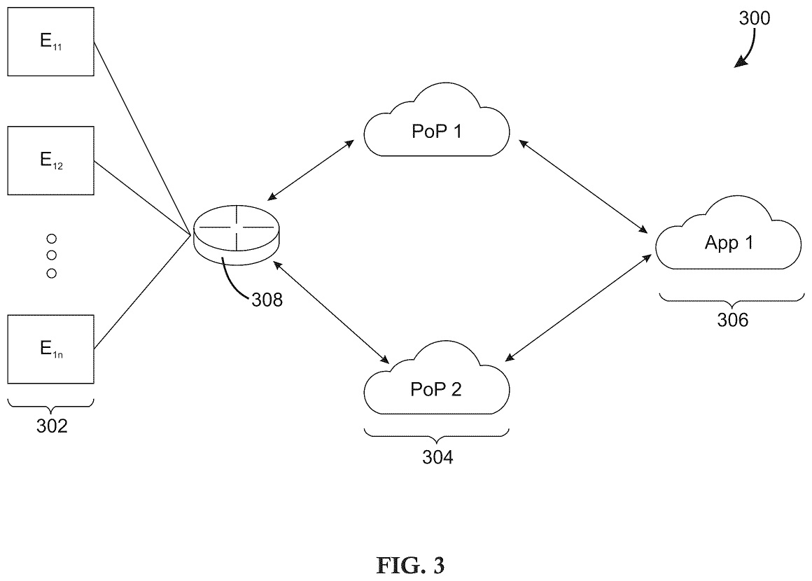

FIG. 3 illustrates an example of an edge router connecting to a cloud-hosted application via multiple points-of-presence (PoPs);

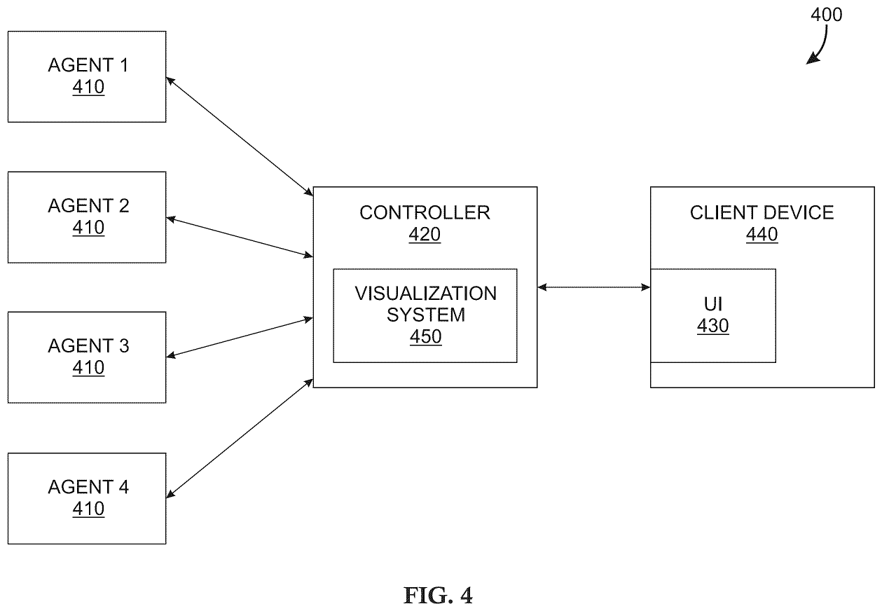

FIG. 4 illustrates an example architecture for a network observability intelligence platform;

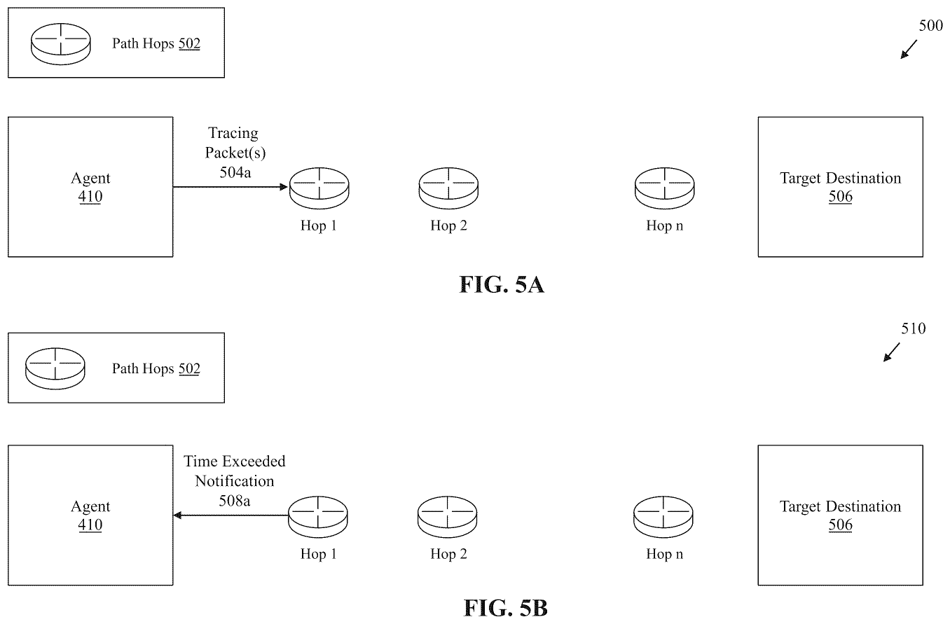

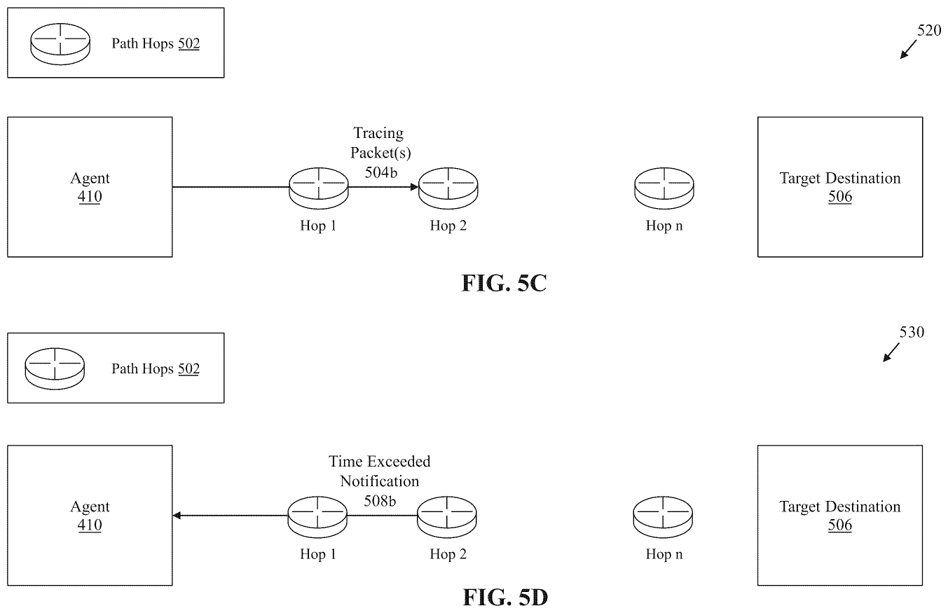

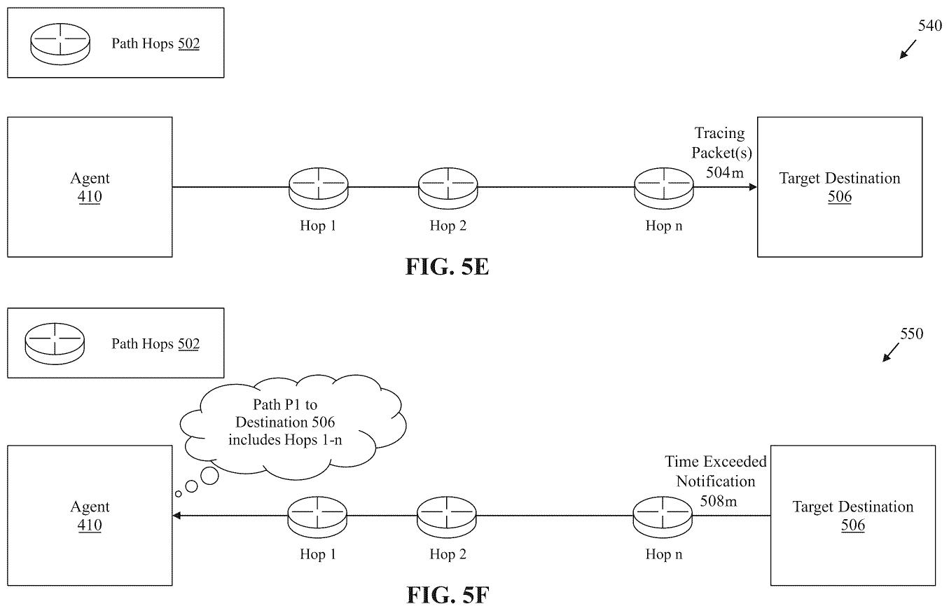

FIGS. 5A-5F illustrate examples of an agent performing automatic path tracing along a network path;

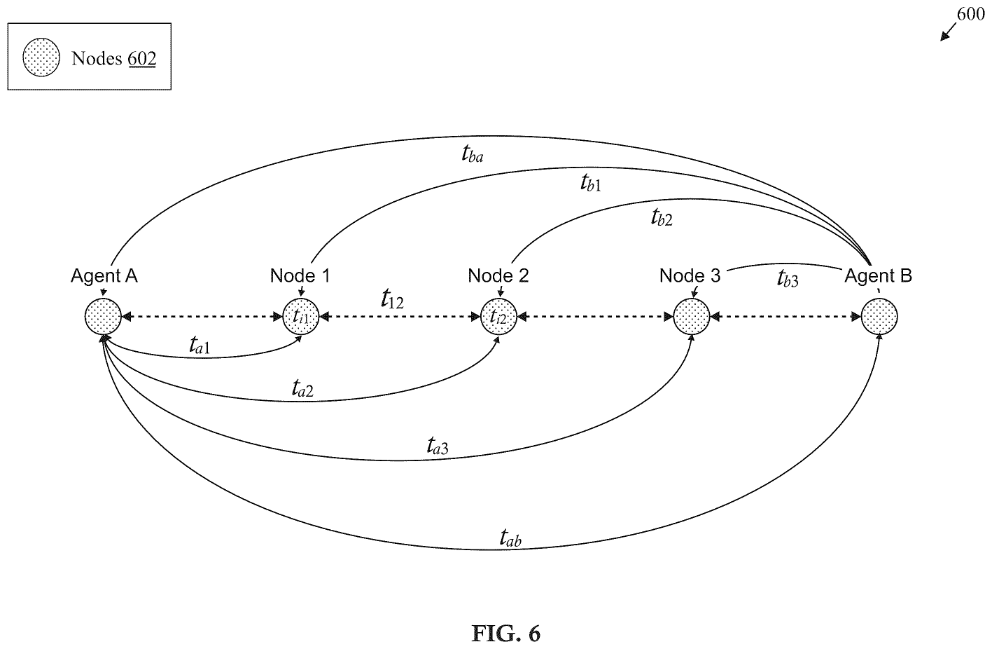

FIG. 6 illustrates an example of agents performing path tracing in opposite directions along a network path;

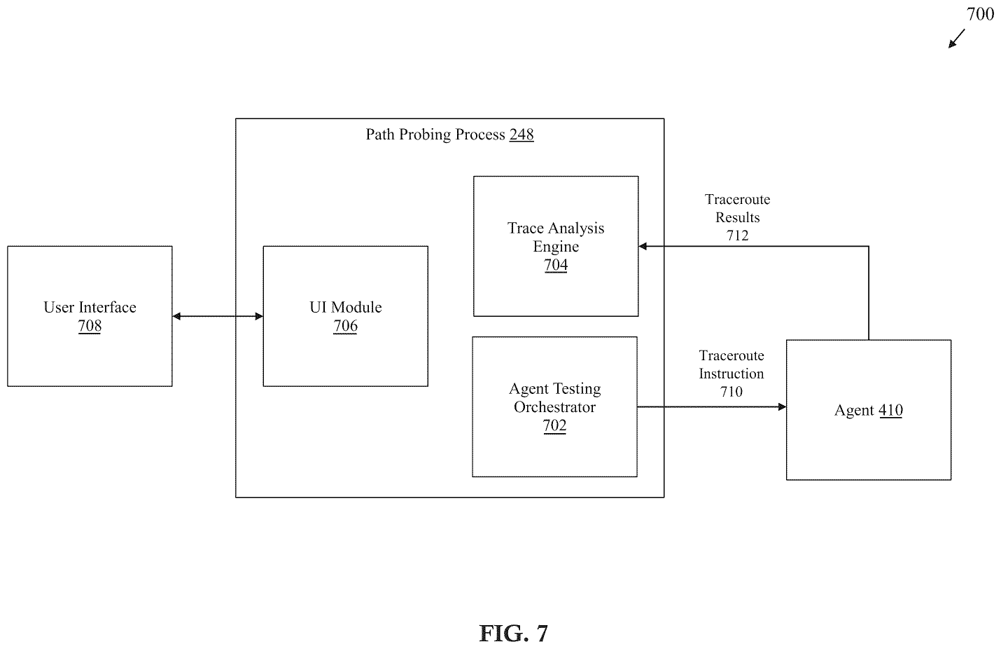

FIG. 7 illustrates an example architecture for bi-directional traceroute for link and node latency estimations;

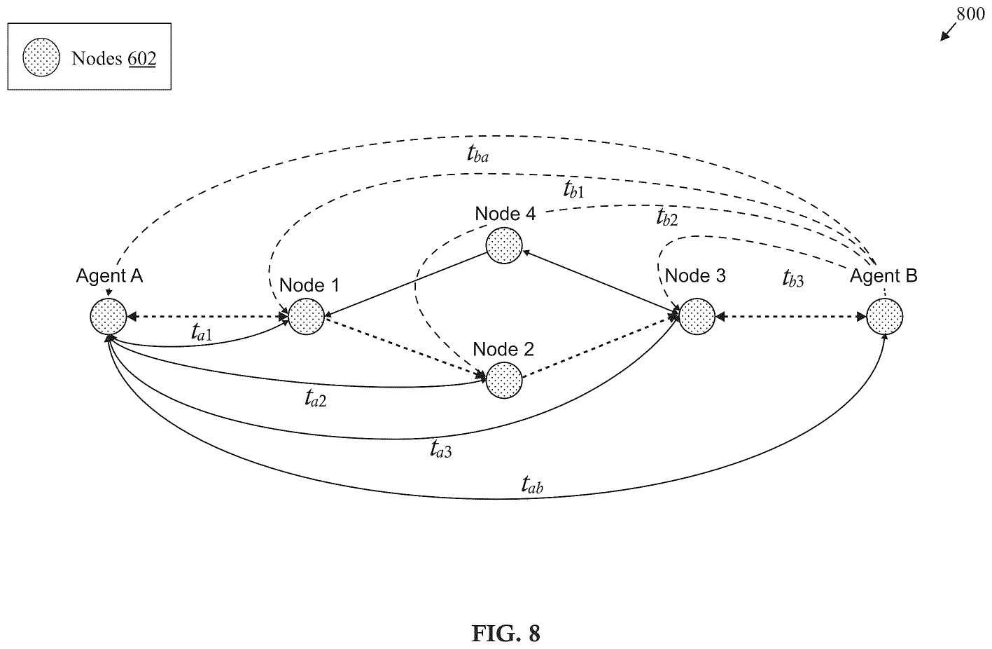

FIG. 8 illustrates an example of the architecture of FIG. 7 performing bi-directional traceroute testing; and

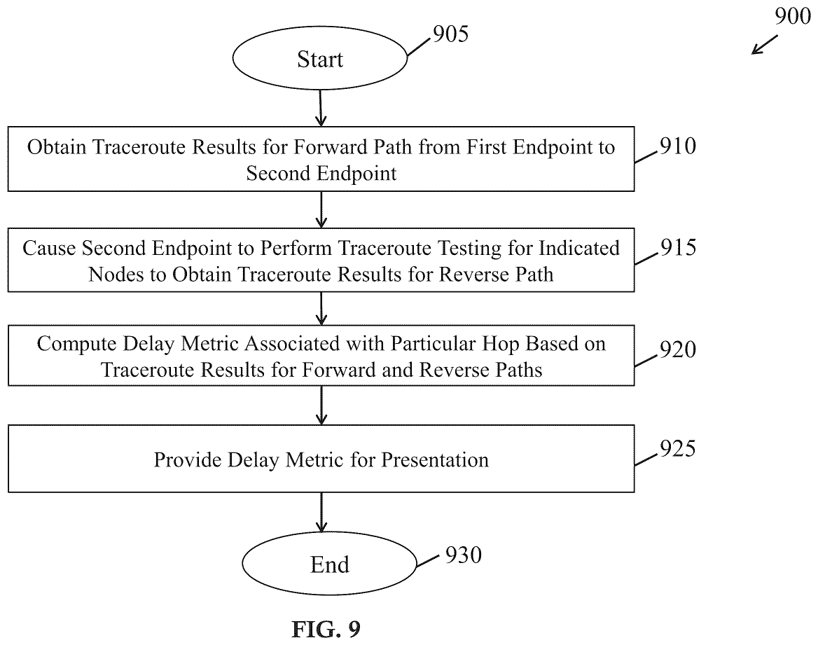

FIG. 9 illustrates an example simplified procedure for performing bi-directional traceroute testing for link and node latency estimations.

### DESCRIPTION OF EXAMPLE EMBODIMENTS

### Overview

According to one or more implementations of the disclosure, a device obtains traceroute results for a forward path from a first endpoint in a network to a second endpoint in the network that indicates a plurality of intermediate nodes along the forward path. The device causes the second endpoint to perform traceroute testing with respect to the plurality of intermediate nodes, to obtain traceroute results for a reverse path between the second endpoint and the first endpoint that includes the plurality of intermediate nodes. The device computes a delay metric associated with a particular intermediate node among the plurality of intermediate nodes, based on the traceroute results for the forward path and the traceroute results for the reverse path. The device provides the delay metric for presentation via a user interface.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in computer network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of computer network 100 in greater detail, according to various embodiments. As shown, network backbone 130 may provide connectivity between devices located in different geographical areas and/or different types of local networks. For example, computer network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in computer network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of computer network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the computer network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a path probing process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, path probing process 248 may also include computer executable instructions that, when executed by processor(s) 220, cause device 200 to perform the techniques described herein. To do so, in some embodiments, path probing process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, path probing process 248 may employ one or more supervised, unsupervised, or semi-supervised machine learning models. Generally, supervised learning entails the use of a training set of data, as noted above, that is used to train the model to apply labels to the input data. For example, the training data may include sample telemetry and/or path performance data that has been labeled as being indicative of a path performance level. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path probing process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

In further embodiments, path probing process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like.

FIG. 3 illustrates an example 300 of an edge router 308 accessing a cloud-hosted application or service 306. As shown, assume that there are n-number of endpoints 302 at a particular location for which edge router 308 provides external connectivity. An online application or service provider may maintain any number of points-of-presence (PoPs), such as PoPs 304, to which edge router 308 may connect. Accordingly, edge router 310 may access a cloud-hosted application or service 306, such as a SaaS application, via a first PoP among PoPs 304, a second PoP among PoPs 304, etc.

However, the network performance when accessing the cloud-hosted application or service 306 via PoPs 304 is not guaranteed. Indeed, ensuring that traffic SLAs are met may require adjustments:
To meet SLAs, exceptions might be required for traffic that should not be sent through the gateway but directly sent via Direct Internet Access (DIA) locally, in case the gateway is not able to provide a good enough performance for a specific kind of traffic, which highly depends on Peering between the Online application or service provider Gateway PoP and SaaS provider or intermediate Autonomous Systems (AS). For instance, it is sometimes recommended to send out VoIP traffic directly DIA to achieve better performance. However, this defeats the purpose of delivering WAN and security directly in the cloud while relying only on a very simple unique tunnel from all locations.
Selection of the “closest POP” is usually based on either geo-location, AnyCast (e.g., for secure web gateways relying on HTTPS proxies), probing results (e.g., selecting the POP with the lowest latency), or by fixing a static PoP location (e.g., as is usually done when setting up fixed IPsec tunnels). However, online application or service providers tend to have rather dense sets of PoPs to which a location can connect. Thus, the closest POP is not always the best one to use, in terms of providing the best possible application experience. In particular, a POP might be struggling at certain times of the day to satisfy the SLA of the application traffic, while other nearby PoPs might not.
The performance of a given POP can also vary between applications. Indeed, performance can be influenced by any or all of the following factors:
   Edge to PoP.
   POP load.
   PoP to PoP, if traffic is sent through a backbone.
   PoP to SaaS. Different PoPs might have different types of inter-connect or peering with SaaS services and might end up going to different SaaS physical endpoints, even if the SaaS exposes a single logical endpoint.

As discussed with respect to illustrative FIG. 4 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 4 is a block diagram of an example observability intelligence platform 400 that can implement one or more aspects of the techniques herein (e.g., through execution of path probing process 248). The observability intelligence platform is a system that monitors and collects metrics of performance data for a network and/or application environment being monitored. At the simplest structure, the observability intelligence platform includes agents 410 (e.g., one or more agents) and one or more servers and/or controllers, such as the controller 420 (e.g., a device 200). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 420 (or controllers) as directed. Note that while FIG. 4 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents 410 may allow a controller to monitor performance of the application to determine such things as device metrics (e.g., type, configuration, resource utilization, etc.), network browser navigation timing metrics, browser cookies, application calls and associated pathways and delays, other aspects of code execution, etc.

Moreover, if a customer uses agents to run tests, probe packets may be configured to be sent from agents 410 to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page, i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 420 is the central processing and administration server for the observability intelligence platform. The controller 420 may serve a browser-based user interface (UI), which may be referred to as an interface 430 that is the primary interface for monitoring, analyzing, and troubleshooting the monitored environment. Specifically, the controller 420 can receive data from agents 410 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 430. The interface 430 may be viewed as a web-based interface viewable by a client device 440. In some implementations, a client device 440 can directly communicate with controller 420 to view an interface for monitoring data. The controller 420 can include a visualization system 450 for displaying the reports and dashboards related to the disclosed technology. In some implementations, the visualization system 450 can be implemented in a separate machine (e.g., a server) different from the one hosting the controller 420.

Notably, in an illustrative Software as a Service (SaaS) implementation, an instance of controller 420 may be hosted remotely by a provider of the observability intelligence platform 400. In an illustrative on-premises (On-Prem) implementation, an instance of controller 420 may be installed locally and self-administered.

The controllers 420 receive data from different agents, such as the agents 410 (e.g., Agents 1-4) deployed to monitor networks, applications, databases and database servers, servers, and end user clients for the monitored environment. Any of the agents 410 can be implemented as different types of agents with specific monitoring duties. For example, application agents may be installed on each server that hosts applications to be monitored. Instrumenting an agent adds an application agent into the runtime process of the application.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (e.g., an application instance) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

FIGS. 5A-5F illustrate examples of an agent performing automatic path tracing along a network path, in some implementations. As shown in example 500 in FIG. 5A, assume that agent 410 is configured to send one or more tracing packets 504a towards target destination 506 via a path that includes any number of path hops 502 (e.g., a first through n^{th} hop). Tracing packet(s) 504a may have TTL values set very low, causing them to expire when reaching the first hop.

As shown in example 510 in FIG. 5B, when the first path hop determines that the one or more tracing packets 504a have expired, it may return a time exceeded notification 508a to agent 410. This allows agents 410 to determine that the first hop is located along the path to target destination 506. In turn, agents 410 may send out tracing packet(s) 504b with increased TTL values, as shown in example 520 in FIG. 5C. Here, since the TTL was increased, those packets may expire prior to reaching the second hop, which then returns time exceeded notification 508b to agent 410. From notification 508b, agent 410 is then able to identify the second hop along the path to target destination 506.

Agent 410 may continue conducting its probing until, as shown in example 540 in FIG. 5E, its tracing packet(s) 504m reach target destination 506. In turn, target destination 506 may send a time exceeded notification 508m back to agents 410, as shown in example 550 in FIG. 5F. This allows 410 (or the entity analyzing its tracing results) to identify the path P1 to target destination 506 in the network as comprising hops 1-n. Such information is important both for purposes of assessing the performance of the path, as well as determining the root cause of any issues that arise.

As noted above, while traceroute testing from one endpoint to another is able to capture metrics such as packet loss and latency, doing so does not provide any information regarding the processing latencies introduced by each intermediate node, nor to the delay over each of the links between the intermediate nodes. One potential way to obtain this information would be to perform traceroute testing in both directions.

By way of example, FIG. 6 illustrates an example 600 of agents performing path tracing in opposite directions along a network path. As shown, assume that there is a plurality of nodes 602 located along a particular path in a network. At the two endpoint nodes 602 may be agents (e.g., agents 410), denoted “Agent A” and “Agent B.” Interconnecting Agent A and Agent B along the path may be various other nodes, such as intermediate nodes “Node 1,” “Node 2,” and “Node 3.”

By having Agent A conduct traceroute testing towards Agent B, the traceroute results will produce the following round trip time (RTT) metrics:
t_{a*}=RTT between Agent A and each node along the forward path
t_{b*}=RTT between Agent B and each node along the revserse path

The system can then use this information to compute the processing delay of each intermediate node 602 as follows:

$${t}_{i 1} = ( \frac{{t}_{a 1} + {t}_{b 1} + {t}_{ab}}{2} )$$

$${t}_{i 2} = ( \frac{{t}_{a 2} + {t}_{b 2} + {t}_{ab}}{2} )$$

$${t}_{i 3} = ( \frac{{t}_{a 3} + {t}_{b 3} + {t}_{ab}}{2} )$$

Similarly, the RTT metrics from both traceroute tests can be used to estimate the link delays of each link. For instance, the link delay t₁₂ for the link between Node 1 and Node 2 can be computed as follows:

$${t}_{12} = ( {t}_{a 2} - {t}_{i 2} ) - ( {t}_{a 1} - {t}_{i 2} )$$

However, in practice, the above approach of having the agent of each endpoint node conduct traceroute testing towards the other endpoint rarely produces the information needed to estimate the delays associated with each intermediate node and/or link. Indeed, it is common to observe a mismatch between the forward and reverse paths between two endpoints. Even when those paths match, it is often impossible to map multiple interfaces to the same device only using the traceroute results, as each agent is likely to get the ICMP response from different router interfaces. It is also impractical to expect that the controller overseeing the testing has knowledge of the configurations of each of the intermediate nodes.

### ——Bi-Directional Traceroute for Link and Node Latency Estimations——

The techniques introduced herein overcome the limitations of standard traceroute approaches, thereby allowing for the estimation of the hop-by-hop link and node delays. In some aspects, the techniques herein do so by coordinating the two endpoints of the test and using the intermediate test results to drive the probing workflow. Rather than assuming that the reverse path will match the forward path, the techniques herein instruct the agent of the opposing endpoint to conduct its traceroute testing based on the results of the traceroute testing of the forward path.

Illustratively, the techniques described herein may be performed by hardware, software, and/or firmware, such as in accordance with path probing process 248, which may include computer executable instructions executed by the processor 220 (or independent processor of interfaces 210) to perform functions relating to the techniques described herein.

Specifically, according to various embodiments, a device obtains traceroute results for a forward path from a first endpoint in a network to a second endpoint in the network that indicates a plurality of intermediate nodes along the forward path. The device causes the second endpoint to perform traceroute testing with respect to the plurality of intermediate nodes, to obtain traceroute results for a reverse path between the second endpoint and the first endpoint that includes the plurality of intermediate nodes. The device computes a delay metric associated with a particular intermediate node among the plurality of intermediate nodes, based on the traceroute results for the forward path and the traceroute results for the reverse path. The device provides the delay metric for presentation via a user interface.

Operationally, FIG. 7 illustrates an example architecture 700 for bi-directional traceroute for link and node latency estimations, in various implementations. As shown, path probing process 248 may include any or all of the following components: an agent testing orchestrator 702, a trace analysis engine 704, and/or a UI module 706. As would be appreciated, the functionalities of these components may be combined or omitted. In addition, these components may be executed in a device or in a distributed manner, in which case the combination of executing devices can be viewed as their own singular device for purposes of executing path probing process 248.

In various implementations, path probing process 248 may be operable to for a match between the traceroute testing of the forward and reverse paths, thereby allowing it to identify and match the measurements related to each hop taken from both ends of the path. To this end, path probing process 248 may provide supervisory control over any number of path probing agents, such as agent 410 shown.

According to various implementations, agent testing orchestrator 702 may be in charge of distributing the configurations to the agents and collecting the testing results. For instance, agent testing orchestrator 702 may send traceroute instructions 710 to agent 410, thereby instructing it to perform traceroute testing in accordance with those instructions. As detailed further below, agent testing orchestrator 702 may work in conjunction with trace analysis engine 704, to determine the appropriate traceroute instructions 710 for any given agent 410. Generally, trace analysis engine 704 may be in charge of applying statistical analysis and/or machine learning techniques to the resulting traceroute results 712, in order to drive the subsequent testing round and estimate the target metrics.

In some cases, agent testing orchestrator 702 may also interact with network management services, in order to retrieve information about the known nodes (such as an IP address, ASN, or geolocation, if available). Agent testing orchestrator 702 may further interact with an end user by operating in conjunction with UI module 706. For instance, UI module 706 may inface with a user interface (UI), such as user interface 708, to allow an end user to define testing policies for agent testing orchestrator 702. Such policies may include parameters like the maximum allowed number of testing rounds or the test frequency, for instance.

As a first step, agent testing orchestrator 702 may send traceroute instructions 710 to a first agent 410 (“Agent A”), instructing it to perform traceroute tracing with respect to another agent 410 (“Agent B”) located at another endpoint. For instance, traceroute instructions 710 may include parameters such as the identity of the other agent/endpoint, the number of attempts that agents 410 should make, the testing interval, or the like.

Upon reception of such message, the agent “A” (agent 410) may perform the traceroute testing specified by traceroute instructions 710 and return the resulting traceroute results 712 to trace analysis engine 704 for analysis.

Subsequently, trace analysis engine 704 may send a reverse traceroute configuration request to agent testing orchestrator 702. Such a message may include, for instance, any or all of the following:
The test results included in traceroute results 712
Available metadata about each hop in traceroute results 712

In turn, agent testing orchestrator 702 may send out new traceroute instructions to the opposing endpoint agent (e.g., another agent 410 denoted “Agent B”) on the opposite end of the forward path probed by agent 410 shown. Note that the semantic of such an instruction is not the same as that for the forward path. The latter may only include limited information regarding the target endpoint for the traceroute testing (Agent B in this case), whereas the former may also specify a list of intermediate nodes on the path between Agent A and Agent B, as indicated by traceroute results 712.

As already mentioned, trace analysis engine 704 may perform statistical analysis (and, depending on the specific implementation, may make use of machine learning/artificial intelligence) over the raw test results from the agents, to determine the path characteristics and ultimately estimate the path metrics. In greater details, the first main responsibility of trace analysis engine 704 is to process the contents of traceroute results 712 from the forward path and identify the sequence of nodes that path between Agents A and B. This is potentially nontrivial, as the forward test may exhibit different sequences of hops. The reason for this is that the underlying hop discovery mechanism used by traceroute cannot guarantee the match between the sequence of hops in a trace and the actual network topology, as each individual probe may follow different paths (e.g., by traversing load balancers or having different routing policies at different testing times).

In various instances, trace analysis engine 704 may compute any or all of the metrics below, to determine whether a reverse path is even eligible for application of the techniques herein:
Path stability: this metric is a measure of how the path(s) vary over a testing session based on factors such as:
   The number of unique forward paths (e.g., unique hops, by interface, ASN and locations as well as their specific sequence) and their frequency
   Path lengths (number of hops)
   Distribution of RTT measurements, on each hop as well as the target
Path coverage: this metric may be based on the number of white nodes (e.g., hops where a response was not received) over the total hop count, for each detected forward path.

For each candidate path, trace analysis engine 704 may then process these metrics to determine whether the path is acceptable for reverse testing. More specifically, trace analysis engine 704 may compare these metrics to configured rules, assess them using statistical analysis, or even classify them using a machine-learning-based classifier, to make that determination. Typically, trace analysis engine 704 may rely on criteria/policies specified by a user via user interface 708 and UI module 706.

Trace analysis engine 704 may then notify agent testing orchestrator 702 as to the list of candidate path(s) that passed the stability and/or coverage criteria, along with their identifiers and metadata (including the hop list and a weight/score for each path). In turn, agent testing orchestrator 702 may convert this information into corresponding traceroute instructions for Agent B of the candidate path.

In some cases, trace analysis engine 704 may even determine that none of the candidate paths are eligible for reverse testing. In these instances, agent testing orchestrator 702 will not initiate the enhanced reverse tracing herein.

FIG. 8 illustrates an example 800 of the architecture of FIG. 7 performing bi-directional traceroute testing, in various implementations. Consider again the example in FIG. 6 whereby Agent A exists as a first endpoint along a forward path with Agent B at the opposing endpoint. Interconnecting the two endpoints/agents are Nodes 1-3.

As described previously, agent testing orchestrator 702 may first instruct Agent A to perform traceroute testing with respect to Agent B. Doing so will result in traceroute results for the forward path indicating the presence of the intermediate Nodes 1-3 between Agent A and Agent B, as well as the metrics tₐ₁, tₐ₂, tₐ₃, and tab, which represent the RTTs between Agent A and Node 1, Node 2, Node 3, and Agent B, respectively. These results are then passed back to trace analysis engine 704 for analysis.

Once trace analysis engine 704 has identified a stable path as the result of the forward traceroute discovery, agent testing orchestrator 702 may send new traceroute instructions to Agent B that request that it perform traceroute testing in the reverse path. More specifically, agent testing orchestrator 702 may instruct Agent B to perform traceroute testing that also targets each of the intermediate Nodes 1-3 located along the forward path, as indicated in the results captured by Agent A. Such traceroute testing will result in metrics t_{ba}, t_{b1}, t_{b2}, and t_{b3}, which represent the RTTs between Agent B and Agent B, Node 1, Node 2, Node 3, respectively.

As would be appreciated, it is often the case that the forward path from a first endpoint to another does not match that of the routing path taken from that other endpoint back to the first endpoint. For instance, as shown, consider the case in which the routing path from Agent B to Agent A traverses Node 4 instead of Node 2. In such a case, simply having Agent B perform traceroute testing that targets Agent A would result in the testing passing along the path that includes Node 4. However, by forcing Agent B to conduct its testing in accordance with the results of the testing conducted by Agent A, the system is able to capture the relevant metrics from both directions of the same path.

Referring again to FIG. 7, Agent B may also report the traceroute results of its own testing back to trace analysis engine 704 for analysis. Another function of trace analysis engine 704 is to combine the results of the forward and reverse tests for a given pair of agents, to compute estimates of the delays associated with the intermediate nodes themselves and/or the individual links along the path. In some cases, trace analysis engine 704 may do so by first verifying consistency of the testing results. In greater detail, trace analysis engine 704 may aggregate all of the test results, for each agent pair, including data and metadata from the forward and reverse paths, over a specified time window (e.g., 5 minutes, or a longer time window depending on the number of available datapoints), to estimate the delays by single node or link. Trace analysis engine 704 may also verify the consistency between the distribution of forward and reverse path delays for each hop and the distribution of deltas compared to end-to-end latency measurements. To do so, trace analysis engine 704 may leverage any number of suitable statistical analysis or machine learning techniques, such as clustering or change point detection.

For datasets whose consistency is validated by trace analysis engine 704, trace analysis engine 704 may then estimate the link and node delay metrics and store them. In turn, UI module 706 may provide any or all of the delay metrics for presentation by user interface 708 to a user, such as a network administrator.

In some implementations, UI module 706 may also compare the estimated delay metrics to historical data, to detect variations that reveal network disruptions. For instance, trace analysis engine 704 may track and assess any or all of the following metrics for variations:
Number of total vs. stable paths for each agent pair
Forward vs. reverse path latency consistency
Internal host/router delay
Individual link latency

Trace analysis engine 704 may apply any number of machine learning or statistical techniques to assess variations in any of these metrics, such as by using an anomaly detection technique to detect significant changes. When trace analysis engine 704 detects any such variation, it may provide an indication of this to user interface 708 via UI module 706, accordingly. In some instances, the user of user interface 708 may also be able to specify parameters for triggering specific alerts when trace analysis engine 704 detects such changes.

FIG. 9 illustrates an example of a simplified procedure 900 (e.g., a method) for performing bi-directional traceroute testing for link and node latency estimations, in accordance with one or more embodiments described herein. For example, a non-generic, specifically configured device (e.g., device 200) may perform procedure 900 by executing stored instructions (e.g., path probing process 248). The procedure 900 may start at step 905, and continues to step 910, where, as described in greater detail above, the device may network to a second endpoint in the network that indicates a plurality of intermediate nodes along the forward path. In some instances, the device may have also instructed the first endpoint to perform traceroute testing of the forward path to obtain the traceroute results. In one implementation, the second endpoint is associated with a point of presence (POP) in the network.

At step 915, as detailed above, the device may cause the second endpoint to perform traceroute testing with respect to the plurality of intermediate nodes, to obtain traceroute results for a reverse path between the second endpoint and the first endpoint that includes the plurality of intermediate nodes. In various implementations, the device may first determine whether the reverse path is suitable for traceroute testing, prior to causing the second endpoint to perform traceroute testing with respect to the plurality of intermediate nodes. In one implementation, the device determines whether the reverse path is suitable for traceroute testing based in part on a measure of stability associated with the forward path. In another implementation, the device determines whether the reverse path is suitable for traceroute testing based in part on a number of intermediate nodes along the forward path that did not respond during generation of the traceroute results for the forward path.

At step 920, the device may compute a delay metric associated with a particular intermediate node among the plurality of intermediate nodes, based on the traceroute results for the forward path and the traceroute results for the reverse path, as described in greater detail above. In some implementations, the delay metric is a node processing delay of the particular intermediate node. In further implementations, the delay metric is a link delay of a link associated with the particular intermediate node.

At step 925, as detailed above, the device may provide the delay metric for presentation via a user interface. In further implementations, the device may also use a machine learning model to make a determination that the delay metric is associated with a network disruption and provide, based on the determination, an indication of the network disruption for presentation via the user interface.

Procedure 900 then ends at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments for performing bi-directional traceroute testing for link and node latency estimations, it is to be understood that various other adaptations and modifications may be made within the spirit and scope of the embodiments herein. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
obtaining, by a device, traceroute results for a forward path from a first endpoint in a network to a second endpoint in the network that indicates a plurality of intermediate nodes along the forward path;
causing, by the device, the second endpoint to perform traceroute testing with respect to the plurality of intermediate nodes, to obtain traceroute results for a reverse path between the second endpoint and the first endpoint that includes the plurality of intermediate nodes;
computing, by the device, a delay metric associated with a particular intermediate node among the plurality of intermediate nodes, based on the traceroute results for the forward path and the traceroute results for the reverse path; and
providing, by the device, the delay metric for presentation via a user interface.

2. The method as in claim 1, further comprising:
instructing the first endpoint to perform traceroute testing of the forward path to obtain the traceroute results.

3. The method as in claim 1, wherein the reverse path differs from a path in the network from the second endpoint to the first endpoint via which traffic is routed.

4. The method as in claim 1, further comprising:
using a machine learning model to make a determination that the delay metric is associated with a network disruption; and
providing, based on the determination, an indication of the network disruption for presentation via the user interface.

5. The method as in claim 1, wherein the delay metric is a node processing delay of the particular intermediate node.

6. The method as in claim 1, wherein the delay metric is a link delay of a link associated with the particular intermediate node.

7. The method as in claim 1, further comprising:
determining whether the reverse path is suitable for traceroute testing, prior to causing the second endpoint to perform traceroute testing with respect to the plurality of intermediate nodes.

8. The method as in claim 7, wherein the device determines whether the reverse path is suitable for traceroute testing based in part on a measure of stability associated with the forward path.

9. The method as in claim 7, wherein the device determines whether the reverse path is suitable for traceroute testing based in part on a number of intermediate nodes along the forward path that did not respond during generation of the traceroute results for the forward path.

10. The method as in claim 1, wherein the second endpoint is associated with a point of presence (POP) in the network.

11. An apparatus, comprising:
one or more network interfaces;
a processor coupled to the one or more network interfaces and configured to execute one or more processes; and
a memory configured to store a process that is executable by the processor, the process when executed configured to:
obtain traceroute results for a forward path from a first endpoint in a network to a second endpoint in the network that indicates a plurality of intermediate nodes along the forward path;
cause the second endpoint to perform traceroute testing with respect to the plurality of intermediate nodes, to obtain traceroute results for a reverse path between the second endpoint and the first endpoint that includes the plurality of intermediate nodes;
compute a delay metric associated with a particular intermediate node among the plurality of intermediate nodes, based on the traceroute results for the forward path and the traceroute results for the reverse path; and
provide the delay metric for presentation via a user interface.

12. The apparatus as in claim 11, wherein the process when executed is further configured to:
instruct the first endpoint to perform traceroute testing of the forward path to obtain the traceroute results.

13. The apparatus as in claim 11, wherein the reverse path differs from a path in the network from the second endpoint to the first endpoint via which traffic is routed.

14. The apparatus as in claim 11, wherein the process when executed is further configured to:
use a machine learning model to make a determination that the delay metric is associated with a network disruption; and
provide, based on the determination, an indication of the network disruption for presentation via the user interface.

15. The apparatus as in claim 11, wherein the delay metric is a node processing delay of the particular intermediate node.

16. The apparatus as in claim 11, wherein the delay metric is a link delay of a link associated with the particular intermediate node.

17. The apparatus as in claim 11, wherein the process when executed is further configured to:
determine whether the reverse path is suitable for traceroute testing, prior to causing the second endpoint to perform traceroute testing with respect to the plurality of intermediate nodes.

18. The apparatus as in claim 17, wherein the apparatus determines whether the reverse path is suitable for traceroute testing based in part on a measure of stability associated with the forward path.

19. The apparatus as in claim 17, wherein the apparatus determines whether the reverse path is suitable for traceroute testing based in part on a number of intermediate nodes along the forward path that did not respond during generation of the traceroute results for the forward path.

20. A tangible, non-transitory, computer-readable medium storing program instructions that cause a device to execute a process comprising:
obtaining, by the device, traceroute results for a forward path from a first endpoint in a network to a second endpoint in the network that indicates a plurality of intermediate nodes along the forward path;
causing, by the device, the second endpoint to perform traceroute testing with respect to the plurality of intermediate nodes, to obtain traceroute results for a reverse path between the second endpoint and the first endpoint that includes the plurality of intermediate nodes;
computing, by the device, a delay metric associated with a particular intermediate node among the plurality of intermediate nodes, based on the traceroute results for the forward path and the traceroute results for the reverse path; and
providing, by the device, the delay metric for presentation via a user interface.
